(19) United States
(12) Patent Application Publication
(10) Pub. No.: US 2003/0216819 A1
(43) Pub. Date: Nov. 20, 2003

(54) Production management system using order adjustable information contained in process flow

(75) Inventor: Tsuneo Yasuda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/262,877

(22) Filed: Oct. 3, 2002

(30) Foreign Application Priority Data
May 16, 2002 (JP) 2002-141171

(51) Int. Cl. G06F 19/00

(52) U.S. Cl. 700/28; 700/121

(57) ABSTRACT

A process flow (information) (260) has information about treatment of each process, a flow number of each the process, and information (270, 280) indicating whether an execution order of each the process is adjustable. Either of the order adjustable information (270) to indicate that the execution order is adjustable and the order unadjustable information (280) to indicate that the execution order is unadjustable, is supplied to each the process in the flag status, for example. Under a production management system (200), extraction means (220) extracts, by referring to the process flow (260), order adjustable processes each being unexecuted and having the order adjustable information (270), and adjustment means (230) adjusts the execution order of the extracted processes.

### BACKGROUND OF THE INVENTION

1. Field of the Invention

The present invention relates to a production management system and, in particular, to a technique of adjusting the execution order of processes.

2. Description of the Background Art

FIG. 33 is an explanatory diagram of a conventional process flow (process flow information) 261P that is related to a semiconductor device manufacturing. In general, about hundreds of processes are executed to complete a semiconductor device. In the process flow 261P, information related to the respective processes, such as process name, equipment used, process initiation date and time (only the dates are described in FIG. 33), process termination data and time (only the dates are described in FIG. 33), treatment condition, and process status, are described and managed. The “treatment condition” is for example such information that A1 dry etch is performed for 30 seconds. The process status information can be broadly classified into “before treatment,” “in-treatment,” and “finished.” In FIG. 33, a blank space denotes “before treatment.” One row is allocated to one process in the process flow 261P described in tabular form as shown in FIG. 33.

The processes bear individual flow numbers. These flow numbers are also described in the process flow 261P. For example, the flow numbers to one type of product (article) are consecutively numbered 1 through several hundreds.

In general, only an authorized specific engineer is allowed to change the order of processes in the process flow 261P when the production line is in operation. Any line operator cannot perform such a change without a permit. The reason for this is to avoid that some unexecuted process are left by a thoughtless change in the flow number.

FIG. 34 is a flowchart of a production method SP300 when the conventional process flow 261P is used in a manual line. Referring to FIG. 34, a conventional process management method using the process flow 261P will be described below. In this manual line, the line operator performs product transportation and equipment control. Product line on which all these operations are automated is called “fully automatic line.” In some cases, an automated section and non-automated section coexist in one product line.

In the production method SP300, a production management system firstly fetches the process flow 261P (step SP301), then supplies, for example, raw Si wafers (also referred to as “bare wafers”) and materials needed in pattern making, such as masks, to the production line (step SP302).

Then, by referring to the process flow 261P, the production management system proceeds with processes in the order of ascending flow numbers. Specifically, the production management system assigns a processing object to a process having the lowest number among unexecuted processes (step SP303). On a manual line, the line operator initiates the process (treatment) (step SP304), and terminates this process (step SP305).

After the present process is terminated, the production management system refers to the process flow 261P and judges whether there is a process to which a flow number next to that of the present process is appended (i.e., the next process) (step SP306). In the presence of the next process, the production management system changes the assigned process of the processing object to the next process (step SP307). On the manual line, the line operator transports manually the processing object (step SP308). In the absence of the next process, the product is finished and shipped (step SP309).

FIGS. 35 to 38 are schematic explanatory diagrams of the operation of the conventional management system. The contents shown in FIGS. 35 to 38 are displayed on the screen of a terminal computer system (PC) placed in the manufacturing field. Since the processes are executed in the order of ascending flow numbers under the conventional production management system as described above, one processing object is not assigned concurrently to processes using equipment OVL02, OPT10, or SEM15. For instance, the processing object of production number “1902”, which is accompanied with underline for illustration, is assigned only to the equipment OPT10. It is noted that the production number is an identifier that is uniquely appended per processing object (in other words, production lot).

FIG. 39 shows a flowchart of a production method SP400 when the conventional process flow 261P is used in a fully automatic line. In the production method SP400 on the fully automatic line, the manual transportation step SP308 in the production method SP300 on the manual line shown in FIG. 34 is changed to an automatic transportation step SP408. The step SP408 is managed by the conventional production management system. The production system SP400 also proceeds with processes in the order of ascending flow numbers, as in the above-mentioned production method SP300.

Meanwhile, a monitor product for inspection and measurement is employed in such a step that it is impossible to make inspection and measurement by using product. For instance, when an A1 film is deposited on a wafer for production, several monitor wafers as monitor products are firstly treated, wherein bare wafers different from wafers for production are usually used. Immediately thereafter (in the range of time in which the equipment state remains unchanged), the wafers for production are treated. Then, the monitor wafers are used to make measurement of the A1 thickness.

FIG. 40 shows a flowchart of a conventional production method SP600 using a monitor product. Specifically, the production method SP600 uses the conventional process flow 261P on a manual line. A conventional production management method using the process flow 261P will be described by referring to FIG. 40.

In the production method SP600, after A1 sputter process of flow number 39 is initiated (step SP601), a sputter process to the monitor product and the actual product are sequentially terminated (steps SP602 and SP603). Then, the A1 sputter step of flow number 39 is terminated (step SP604). Thereafter, A1 thickness measurement process (measurement to the monitor product) that is flow number 40 is initiated (step SP605) and then terminated (step SP606). Thus, the production management system proceeds with the processes of flow numbers 39 and 40 in this order, that is, in ascending flow number as in the above-mentioned production methods SP300 and SP400.

FIG. 41 shows a flowchart of a conventional production method SP700 using monitor products. The production method SP700 uses the conventional process flow 261P on a fully automatic line. The conventional production management method using the process flow 261P will be described by referring to FIG. 41. The production method SP700 is different from the production method SP600 of FIG. 40 in that step SP701 for issuing a temporary tag for monitor is interposed between steps SP604 and SP605; and that step SP702 for discarding the temporary tag for monitor is performed after step SP606. Also in the production method SP700, the production management system proceeds with processes in ascending flow number, as in the above-mentioned production method SP600.

The term “tag” is one that indicates a product identifier (product number). For example, a tag on which figures “1902” are printed is attached to the product. There is one type of tag per product (i.e., a single production lot). Although the monitor product is not the actual product, a temporary tag is attached thereto for discrimination during automatic transportation, and the temporary tag is then discarded when the monitor product is needless. The normal tag attached to the actual product is discarded when the product is finished and shipped. It is noted that the manual line may sometimes use a temporary tag.

For instance, the inspection processes of flow numbers 98 to 100, as shown in FIG. 33, are independent from one another. Therefore, it is theoretically possible to perform these processes irrespective of flow number. It is also theoretically possible to concurrently perform, for example, the process of flow number 40 to the monitor product while performing the process of flow number 39 to the actual product.

However, under the conventional production management system that proceeds with the processes in ascending flow number by referring to the process flow 261P, as described above, there are the following inconveniences that the order of the processes cannot be changed when the production line is in operation; and that two processes cannot be performed in parallel. The term “change” does not include reediting of the process flow to create a process flow for new product, which causes no real-time influence on the operating production line.

The above-mentioned authorized specific engineer is capable of rearranging the process flow 261P even when the production line is in operation. It is however still difficult to take proper handling to meet the situation because this specific engineer has not been standing by around the clock.

### SUMMARY OF THE INVENTION

It is an object of the present invention to provide a production management system having flexibility in adjusting the execution order of processes.

According to the present invention, a production management system includes process flow fetch means, extraction means, adjustment means, and management means. The process flow fetch means fetches a process flow having information about treatment of each process, flow number of each the process, and information indicating whether an execution order of each the process is adjustable. The extraction means extracts, by referring to the process flow, plural unexecuted order adjustable processes each being unexecuted and having an order adjustable information indicating that its execution order is adjustable. The adjustment means adjusts the execution order of the plural unexecuted order adjustable processes. The management means manages each the process based on a result of adjustment made by the adjustment means.

By the presence of the adjustment means that adjusts the execution order of plural unexecuted order adjustable processes, production time can be reduced than the conventional production management system that manages processes in the order of flow numbers on a process flow. Thereby, the advantages are gained that the date of delivery is reduced and the selling price is lowered. In particular, the use of the information indicating whether the execution order of each process is adjustable will eliminate the necessity to consider each time which process is executable by changing its execution order. This allows for a reduction in loss time required for such consideration. In addition, by the elimination of this consideration, the execution order of each process can be adjusted even if no authorized engineer is present.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic explanatory diagram of a production line to which a production management system according to the present invention is applied;

FIGS. 2 and 3 are schematic explanatory diagrams of a processing object in the present invention;

FIG. 4 is a schematic explanatory diagram of the production management system and process flow in the present invention;

FIG. 5 is an explanatory flowchart of the operation of the production management system of the present invention;

FIG. 6 is a schematic explanatory diagram of a process flow according to a first preferred embodiment of the invention;

FIG. 7 is an explanatory flowchart of the operation of a production management system in the first preferred embodiment;

FIGS. 8 to 14 are schematic explanatory diagrams of the operation of the production management system in the first preferred embodiment;

FIGS. 15 to 18 are schematic diagrams for comparison of the production management system of the first preferred embodiment and a conventional production management system;

FIG. 19 is an explanatory flowchart of the operation of a production management system according to a second preferred embodiment of the present invention;

FIG. 20 is a schematic explanatory diagram of a process flow according to a third preferred embodiment of the invention;

FIG. 21 is a schematic explanatory diagram of a process flow according to a fourth preferred embodiment of the invention;

FIG. 22 is a schematic explanatory diagram of other process flow according to the fourth preferred embodiment;

FIGS. 23 to 29 are schematic explanatory diagrams of the operation of a production management system according to a fifth preferred embodiment of the invention;

FIG. 30 is a schematic diagram for comparison of the production management system of the fifth preferred embodiment and a conventional production management system;

FIG. 31 is an explanatory flowchart of the operation of a production management system according to a sixth preferred embodiment of the present invention;

FIG. 32 is an explanatory flowchart of the operation of a production management system according to a seventh preferred embodiment of the present invention;

FIG. 33 is an explanatory diagram of a conventional process flow;

FIG. 34 is an explanatory flowchart of a conventional production management method using a conventional process flow (in a manual line);

FIGS. 35 to 38 are schematic explanatory diagrams of the operation of a conventional production management system;

FIG. 39 is an explanatory flowchart of a conventional production management method using a conventional process flow (in a fully automatic line);

FIG. 40 is an explanatory flowchart of a conventional production management method using a conventional process flow (when using a monitor product in a manual line); and

FIG. 41 is an explanatory flowchart of a conventional production management method using a conventional process flow (when using a monitor product in a fully automatic line).

### DESCRIPTION OF THE PREFERRED EMBODIMENTS

First Preferred Embodiment

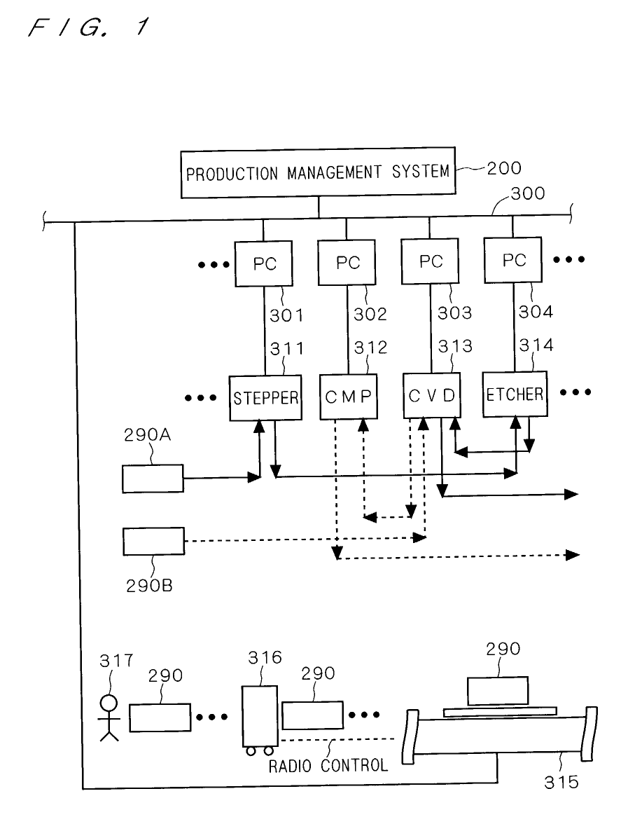

FIG. 1 is a schematic explanatory diagram of a semiconductor device production line to which a production management system 200 according to the present invention is applied.

The production management system 200 can be configured by a general computer system having an input unit such as keyboard, a display unit such as CRT, and a storage unit such as hard disk, etc. The system 200 is placed e.g., in an office, outside of a manufacturing field provided with facilities such as manufacturing equipment, measuring equipment, and inspection equipment, and connected to terminal computers (hereinafter also referred to as “PCs”) 301 to 304 that are placed in the manufacturing field. The production management system 200 may be placed in the manufacturing field. In an alternative, part or all of the PCs 301 to 304 may be placed in the office.

The production management system 200 manages the progress of each process, process flow, and operation situation of each facility. This management information is provided to a line operator and engineer through the PCs 301 to 304, respectively. That is, the production management system 200 and PCs 301 to 304 configure a client server system.

The PCs 301 to 304 control and manage units 311 to 314. As examples of the units 311 to 314, there are a stepper, CMP (chemical mechanical polishing) equipment, CVD (chemical vapor deposition) equipment, and etcher. The PC 301 may control and manage plural steppers 311. This is true for the PCs 302 to 304.

In the range of illustration in FIG. 1, for example, a processing object 290A is treated using a stepper 311, etcher 314, and CVD equipment 313 in the order named, as indicated by arrow-pointed solid lines. A processing object 290B is treated using the CVD equipment 313 and CMP equipment 312 in this order named, as indicated by arrow-pointed broken lines. In general, the facilities are used plural times in order to finish one type of product (a semiconductor device in this instance).

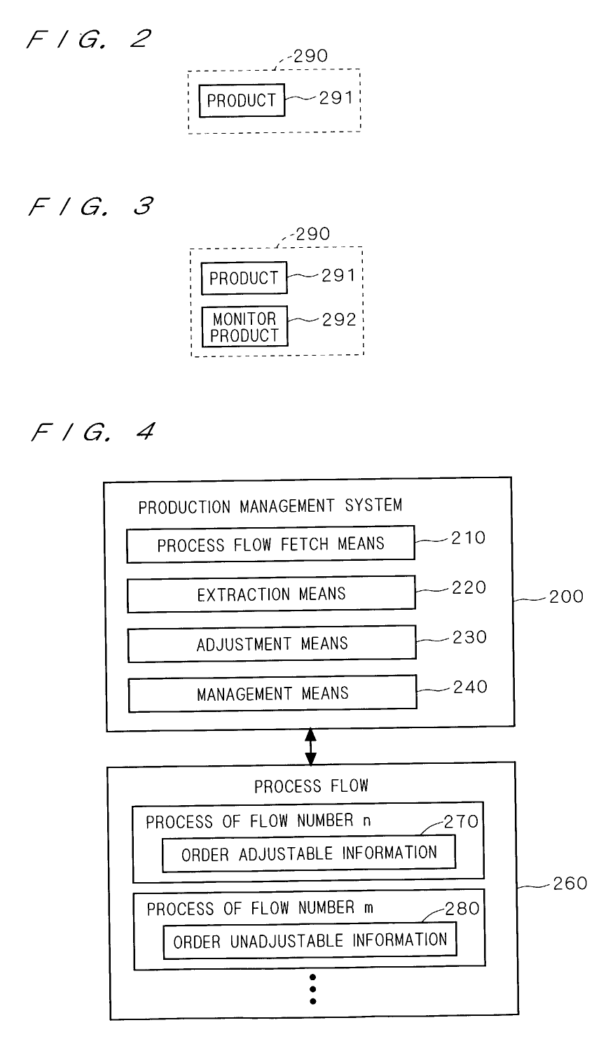

A processing object 290 (the processing objects 290A and 290B) may include a product (or a group of products) 291 alone that is the finally finished product, as shown in FIG. 2. Alternatively, it may include the product 291 and a monitor product 292 (or a group of monitor products), as shown in FIG. 3.

A place where equipments (e.g., plural steppers 311) are disposed collectively is called “bay,” and transportation of the processing object 290 between bays is mechanized and automated by an interbay transportation system 315. A carrier (dolly) 316 performs transportation of the processing object 290 to the individual equipments within the bay. The carrier 316 is under radio control of the interbay transportation system 315. The operation situations of the interbay transportation system 315 are managed by the production management system 200 via a LAN 300. The carrier 316 is managed by the production management system 200 via the interbay transportation system 315 and LAN 300. It is noted that a line operator 317 manually transports the processing object 290 to a place beyond an automatic transportation system.

The production line facilities (e.g., manufacturing equipment, measuring equipment, interbay transportation system, carrier, etc.) to which the production management system 200 is applicable are not to be restricted to the type and number shown in FIG. 1.

FIG. 4 is an explanatory diagram of the production management system 200 and a process flow (or process flow information) 260 to be used by the system 200.

The production management system 200 has a process flow fetch means 210, extraction means 220, adjustment means 230, and management means 240. For instance, a computer program implements these means 210, 220, 230, and 240.

The process flow 260 has information about treatment in each process (which will be described later), flow number of each process, and information 270 and 280 indicating whether the execution order of each process is adjustable or not.

Under the production management system 200, processes described in the process flow 260 are basically (in principle) performed in the order of ascending flow numbers as will be described later. With this in view, their flow numbers are numbered.

The order adjustable information 270 indicates that the execution order of a process accompanied with the information 270 is adjustable, whereas the order unadjustable information 280 indicates that the execution order is unadjustable. Either of the information 270 and 280 is appended to each process. The information 270 and 280 are previously appended until the production management system 200 uses the process flow 260. For example, these information may be appended when the process flow 260 is created.

The process flow 260 may be created on the production management system 200 or on other computer system and retained as a database, in the inside or outside of the production management system 200. There is one type of the process flow 260 per processing object 290 (i.e., a single production lot).

Hereinafter, a process having the order adjustable information 270 is referred to as an “order adjustable process,” and a process having the order unadjustable information 280 is referred to as an “order unadjustable process.”

A basic operation (or production management method) ST200 according to the production management system 200 of the present invention will be described by referring further to a flowchart of FIG. 5.

Before a processing object 290 is supplied to a production line, a process flow fetch means 210 fetches a process flow 260 for the processing object 290 (step ST210). More specifically, the process flow 260 is placed in the condition under which the production management system 200 (i.e., the above-mentioned means 210, 220, 230, and 240) is usable.

By referring to the process flow 260, the extraction means 220 judges whether unexecuted processes have the order adjustable information 270 and extracts plural unexecuted order adjustable processes (step ST220). Then, the adjustment means 230 adjusts the execution order of the extracted unexecuted order adjustable processes (step ST230).

The management means 240 fetches, updates, and manages various information of each process and also conducts each process. For example, the production management system 200 basically proceeds with processes in the order of ascending flow numbers. When the execution order of a process is adjusted by the management means 230, the system 200 proceeds with the corresponding process based on the adjustment result (step ST240). This proceeding is managed and conducted by the management means 240.

Other operations and specific operations of the above-mentioned means 210, 220, 230, and 240 will be described below.

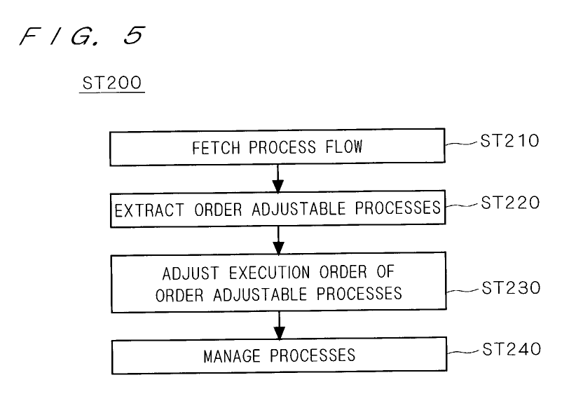

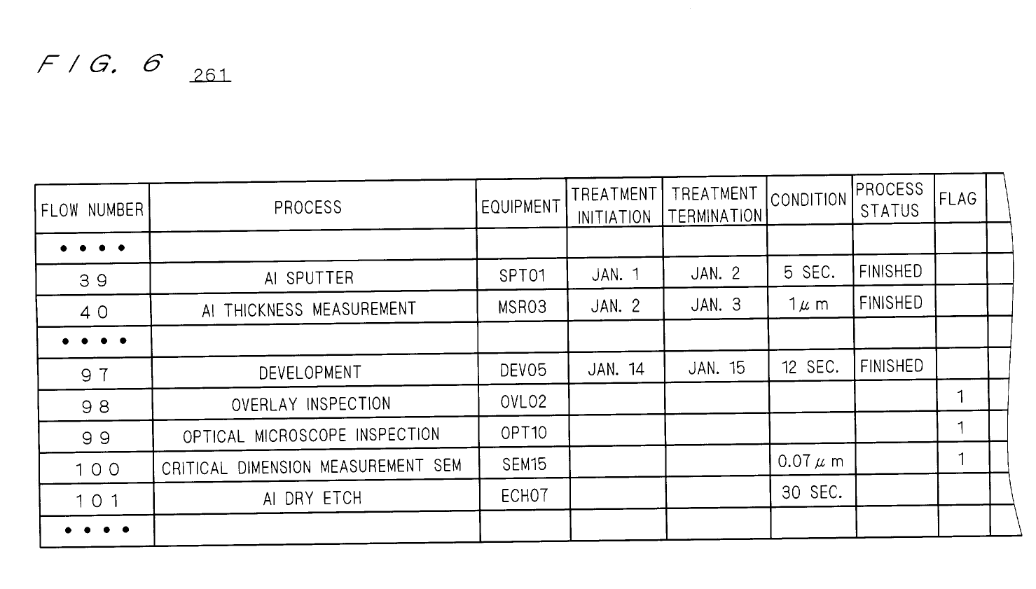

Referring to FIG. 6, a first specific example of the process flow 260 will be described by showing a process flow 261 of the first preferred embodiment. FIG. 6 shows the process flow 261 described in tabular form, wherein one process is allocated one row.

To the process flow 261, the process names, the equipment used, the days and times when a treatment (process) is initiated and terminated (only the dates are described in FIG. 6), treatment condition, and process status information are described and managed per process, as the above-mentioned treatment information. FIG. 6 illustrates the processes of A1 sputter, A1 thickness measurement, development, overlay inspection, optical microscope inspection, critical dimension measurement SEM, and A1 dry etch. The term “treatment condition” means information indicating for example that A1 dry etch is performed for 30 seconds. Process status information can be broadly classified into “before treatment,” “in-treatment,” and “finished.” In FIG. 6 and the following similar figures, blank denotes “before treatment.”

The term “initiation/termination of process” is also referred to as “initiation/termination of treatment.”

The flow numbers of the processes are described in the process flow 261. For instance, the processes of one type of product (article) are numbered 1 through about several hundreds.

Further, flags are provided to the respective processes in the process flow 261. The flag status of a process of which execution order is adjustable (i.e., an order adjustable process) is set to “1”, and the flag status of a process of which execution order is unadjustable (i.e., an order unadjustable process) is set to be blank. Thus, either of the order adjustable information 270 or the order unadjustable information 280 is appended to each process. FIG. 6 illustrates the instance that the flag of overlay inspection process of flow number 98, the flag of optical microscope inspection process of flow number 99, and the flag of critical dimension measurement SEM process of flow number 100 are all set to “1”.

Although FIG. 6 merely shows information related to the above and below description, needless to say, the process flow 261 may contain other information (items).

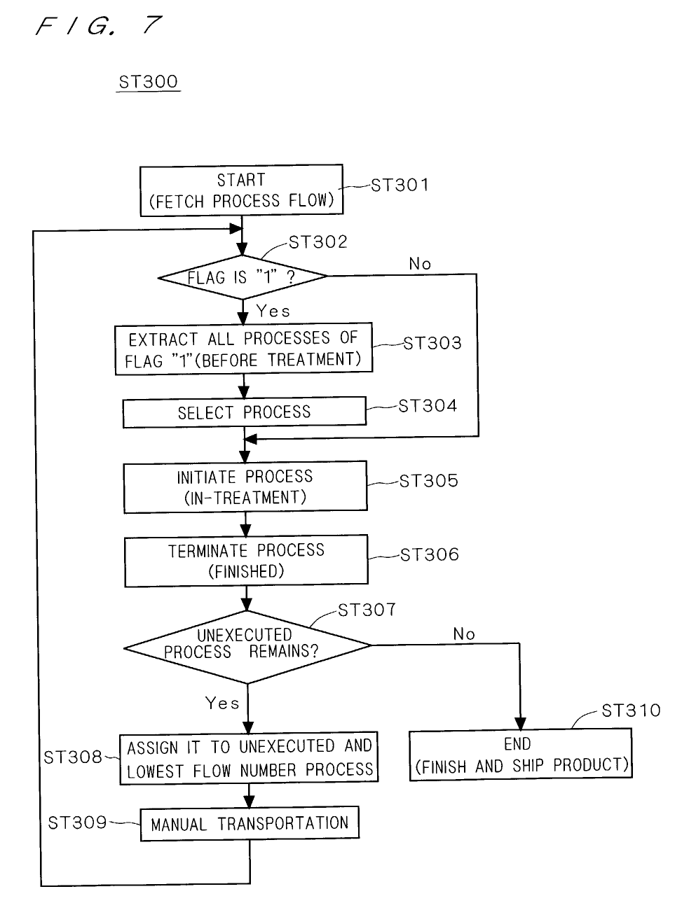

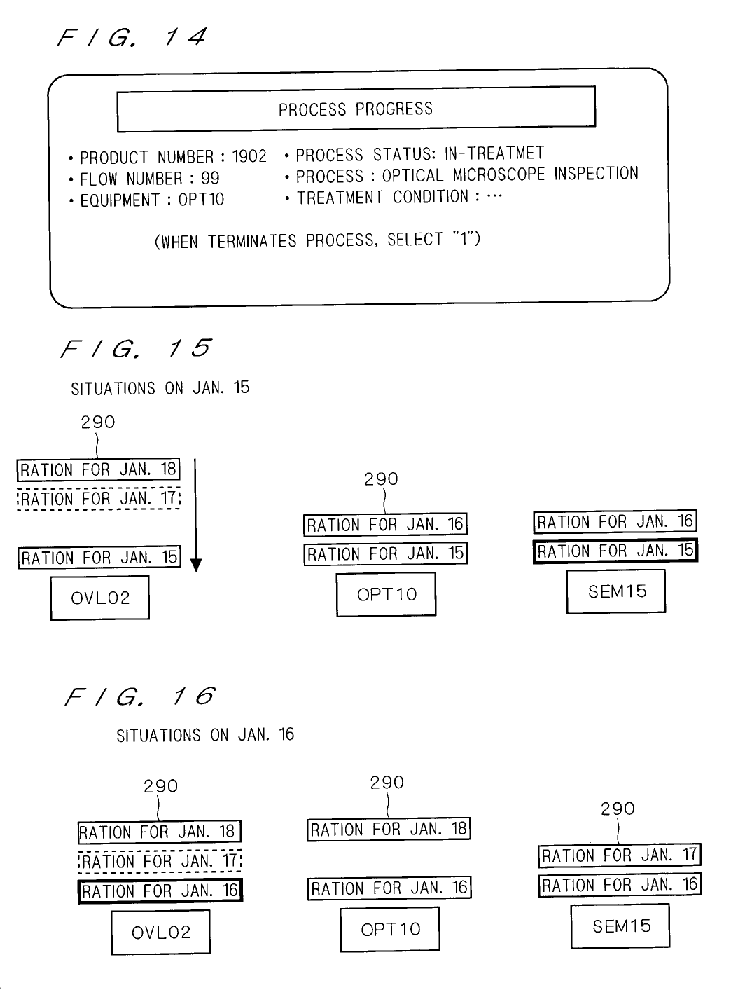

The operation of the production management system 200 of the first preferred embodiment will next be described by referring to FIGS. 7 to 14. FIG. 7 and FIGS. 8 to 14 are respectively a flowchart and schematic diagrams of a semiconductor device manufacturing or production method ST300 in a manual line. FIGS. 8 to 14 are examples of display screens to be displayed on the production management system 200 and/or PCs.

The production management system 200 firstly fetches the process flow 261 by the process flow fetch means 210 (step ST301). At the same time, materials such as raw Si wafers (also called “bare wafers”) and masks etc. necessary for pattern making are supplied to a production line.

The production management system 200 basically (in principle) proceeds with processes in the order of ascending flow numbers. In other words, the system 200 assigns the processing object 290 to processes, namely, decides the assigned processes, in that order. Therefore, the processes to which the processing object 290 is assigned include in principle the lowest flow number process among unexecuted processes. Under the production management system 200, as will be described later, in some cases the processing object 290 is assigned to plural processes including the lowest flow number process. Therefore, the fact that the processing object 290 is assigned to a certain process does not always coincident with the fact that the processing object 290 is actually present in this process.

Before the processing object 290 is subjected to treatment of its presently assigned process (the present process), the extraction means 220 refers to the process flow 261 and judges whether the present process is of flag “1” (step ST302). As the result, the flag of the present process is “1”, the extraction means 220 refers the process flow 261 and extracts all the processes of flag “1” (including the present process) from unexecuted processes, and then assigns the processing object 290 to all the extracted processes (step ST303). In this instance, a single processing object 290 is assigned to plural processes including the lowest flow number process. At this stage, the processing object 290 is not yet subjected to any treatment of the above plural processes (i.e., in the state of “before treatment”).

On the other hand, when the flag of the present process is not of “1” (blank), the operation goes to step ST305 (described later) in the production method ST300.

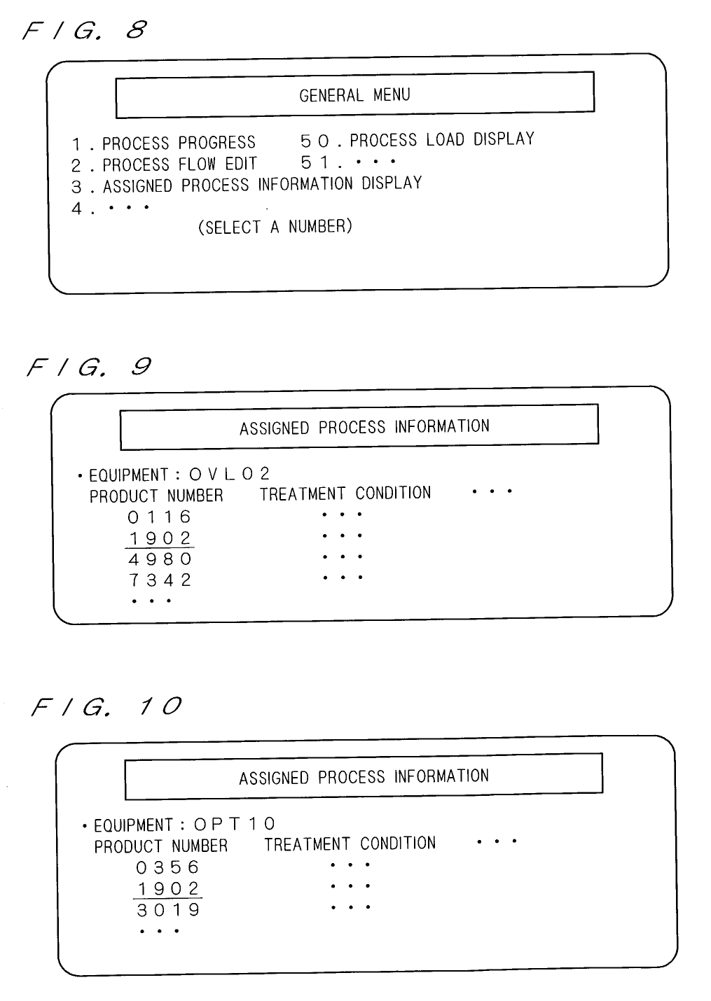

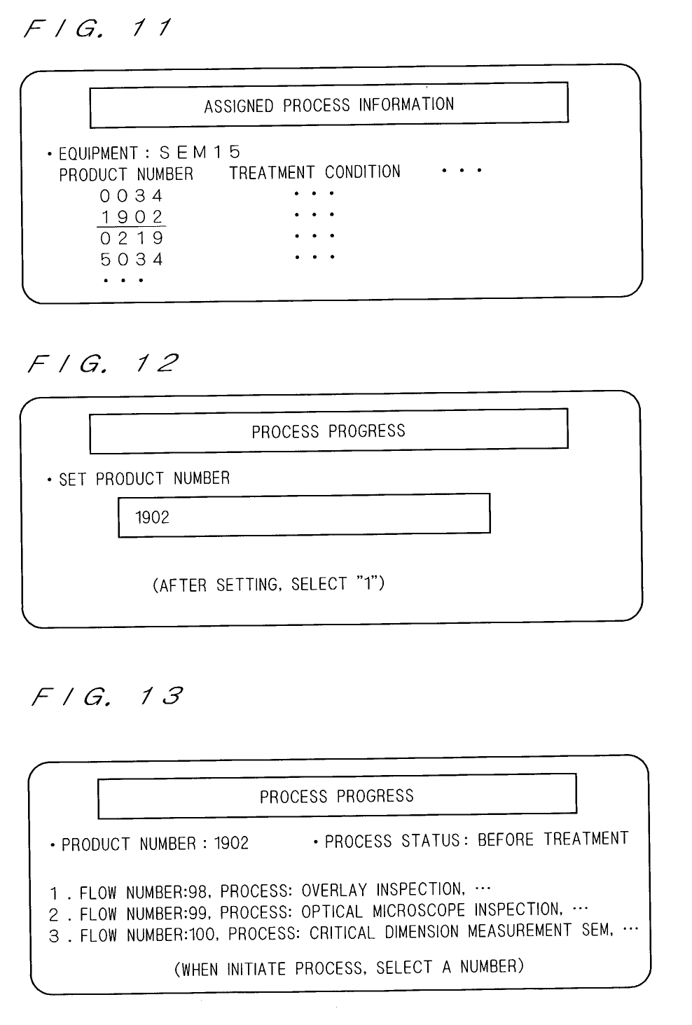

Meanwhile, the line operator 317 can be aware of the type of the processing object 290 assigned to the each process, as shown in FIGS. 9 to 11, by selecting through the PC “3” on a general menu screen in FIG. 8. Under the production management system 200, the processing object 290 of production number “1902” can be assigned to plural processes as shown in FIGS. 9 to 11, wherein the production number “1902” is accompanied with underline for the sake of emphasis. The production number is an identifier that is uniquely appended per processing object 290 (i.e., each production lot).

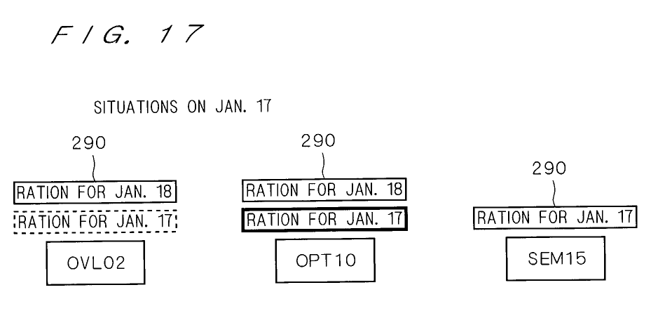

When the line operator 317 proceeds with the process (i.e., initiates treatment of the process) with respect to the processing object 290 of production number “1902,” the line operator 317 selects “1” on the general menu screen of FIG. 8 thereby to obtain such a screen as shown in FIG. 12, and then inputs figures “1902.” In reply to this input, the production management system 200 presents such a screen as shown in FIG. 13 to the line operator 317, so that the line operator 317 selects a desired process (step ST304). Since a single processing object 290 is assigned to plural processes under the production management system 200, as described above, the system 200 presents the screen of FIG. 13 and prompts the line operator 317 to select a desired process. At this time, to adjust the execution order, the adjustment means 230 fetches the input from the line operator 317. The processing object 290 is, as required, transported to the selected process.

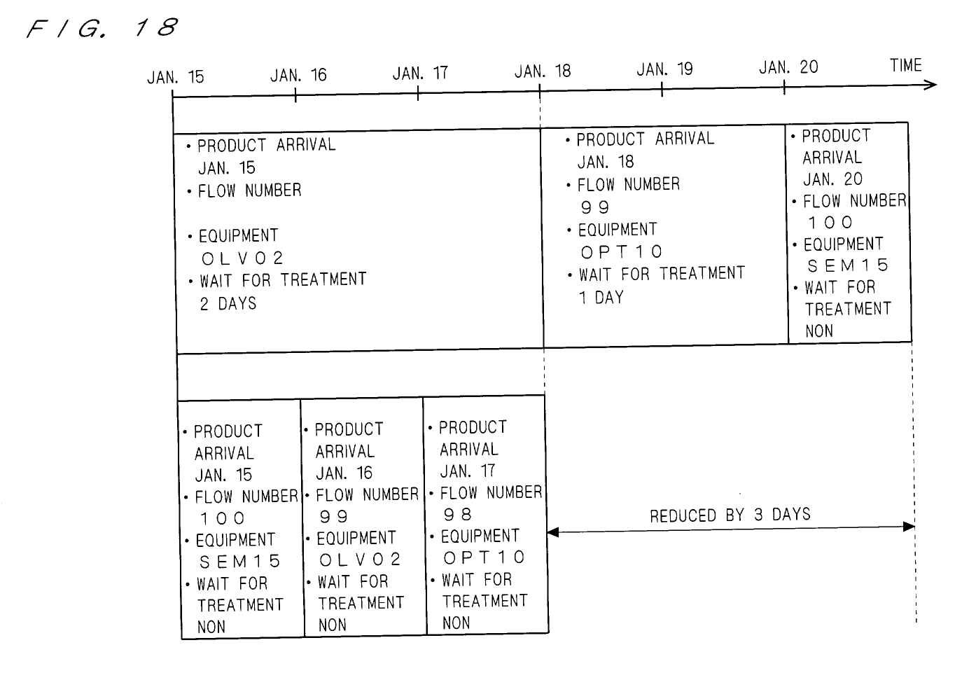

Subsequently, the line operator 317 operates to initiate the process as shown in FIG. 13 (step ST305), and the process is then terminated as shown in FIG. 14 (step ST306). At this time, the adjustment means 230 prompts the line operator 317 to perform operation with a message display etc. Based on a result of adjustment made by the adjustment means 230, the management means 240 performs process status management and the corresponding update of the process flow 261.

Then, the management means 240 refers to the process flow 261 and investigates whether there is any unexecuted process (step ST307). In the presence of the unexecuted process, the processing object 290 is assigned to the lowest flow number process among the unexecuted processes. That is, the assigned process is changed to the lowest flow number process. For instance, if desired to firstly execute the process of flow number 100 among the processes of flow numbers 98 to 100, the processes of flow numbers 98 and 99 remain unexecuted only by changing, after the process of flow number 100 is terminated, the assigned process to the next following process (i.e., the process of flow number 101), as in the conventional production management system (see step SP307 in FIG. 34). This disadvantage is however avoidable because the above-mentioned steps ST307 and ST308 are executed under the production management system 200.

This disadvantage is also avoidable by the following manner. That is, if step ST308 is replaced with the step of updating assignment to the next following step as in the conventional production management system (see step SP307 in FIG. 34), the steps ST302 and ST303 are replaced with the step in which flag judgment is made to all the unexecuted processes in order to extract processes of flag “1”.

Based on the update of the assigned process, the line operator 317 transports manually the processing object 290 (step ST309). Then, the operation goes to the above-mentioned step ST302 in the production method ST300. In the absence of any unexecuted process, the product is finished and shipped (step ST310).

Although the foregoing is directed to the instance that flag judgment is made after the processing object 290 is assigned to other process, flag judgment may be made before treatment is initiated. In an alternative, after the present process is terminated, flag judgment may be made to the next following assigned process (i.e., the lowest flow number process in the unexecuted processes).

In the above-mentioned step ST304, it is preferable to select a desired process by referring to a process load, for example. Selecting the process having the smallest load minimizes the latency time of the processing object 290. The term “process load” means information obtained by overall analysis of the fault rate of the corresponding equipment, throughput (the number of products treated per unit time) of this equipment, schedule of treatment in this process, etc. The process load is fetched and managed by the management means 240, and also supplied to the line operator 317 (see FIG. 8).

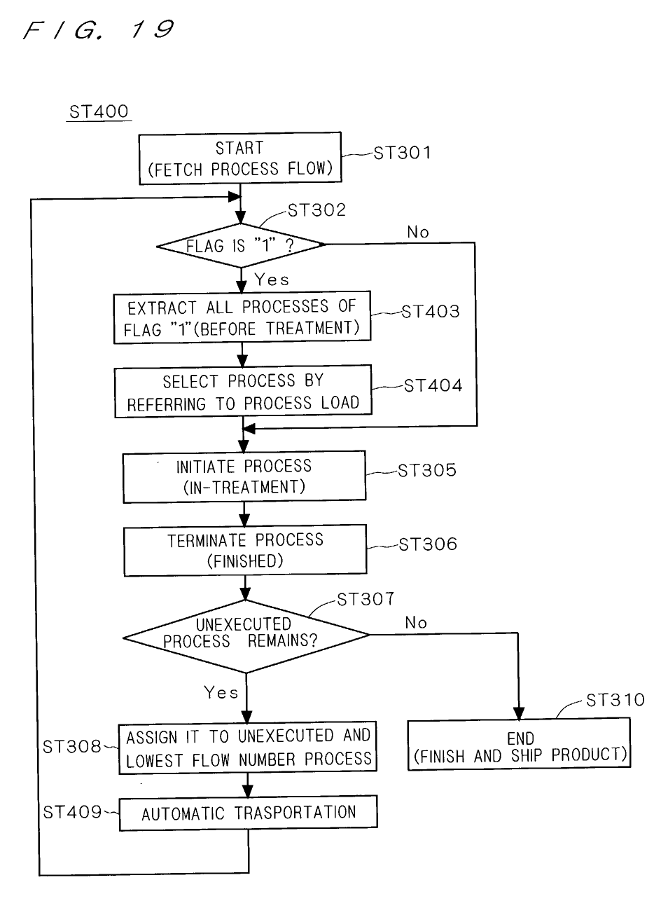

Referring to FIGS. 15 to 18, a method of selecting a process will be described taking only the schedule of each process as a process load, for the sake of simplicity in description. In FIGS. 15 to 17, the processes of flow numbers 98, 99, and 100 are denoted by the corresponding equipments OVL02, OPT10, and SEM15, respectively; the processing object 290 under the production management system 200 is denoted by the square in solid line; and a comparative processing object 290 under the conventional production management system is denoted by the square in broken line. Further, for sake of simplicity, the equipments OVL02, OPT10, and SEM15 are to treat one processing object 290 per day. In FIG. 18, the elapse of time under the conventional production management system and that under the production management system 200 are shown in the upper and lower parts of the drawing, respectively.

First, assuming that on January 15, the processing object 290 is assigned to the equipments OVL02, OPT10, and SEM15, as shown in FIG. 15. That is, by treating the processing object 290 under the production management system 200 with the equipment SEM15 having no processing object 290 in the wait state, this process can be terminated on January 15 (see FIG. 18).

On January 16, by treating the processing object 290 that is under the production management system 200 with the equipment OVL02 having no processing object on January 16 (see FIG. 15), this process can be terminated on January 16 (see FIG. 18).

On January 17, by treating the processing object 290 under the production management system 200 with the equipment OPT10 having no processing object on January 17 (see FIG. 16), this process can be terminated on January 17 (see FIG. 18).

On the other hand, the processing object 290 under the conventional production management system must follow its execution order, and therefore, the treatment with the equipment OVL02 can be terminated on January 17. Thereafter, the treatments with the equipments OPT10 and SEM15 are executed in this order, and all the three processes to the processing object 290 under the conventional production management system are terminated on January 20, as shown in FIG. 18.

In the above instance, under the production management system 200, production time can be reduced by three days than the conventional production management system.

Thus, according to the production management system 200 and the production management method using the same, the adjustment means 230 adjusts the execution order of the unexecuted order adjustable processes. Thereby, the production time can be reduced than the conventional production management system that manages processes in the order of flow numbers on the process flow. In particular, by using the order adjustable information 270 and order unadjustable information 280 on the process flow 260 or 261, there is no need to consider each time as to which process is executable by changing its execution order. It is therefore possible to reduce loss time required for such a consideration. Further, the omission of the above-mentioned consideration enables to adjust the execution order of processes even in the absence of the authorized engineer.

In the meantime, it seems that product needs is determined by selling price, performance, design, date of delivery, after service etc. According to the present invention, an increase in product needs can be prospected by a reduction in selling price and a reduction in date of delivery. Specifically, according to the present invention, a semiconductor device is manufactured by executing its processes in an adjusted execution order. As the result, the production time can be reduced and the date of delivery can be reduced as described above. Furthermore, a reduction in production time leads to a decrease in the maintenance cost of the production line. Therefore, the product cost can be reduced, thereby lowering the selling price.

Second Preferred Embodiment

A second preferred embodiment of the invention is directed to the case of a fully automatic line. The operation of the production management system 200 according to the second preferred embodiment will be described by referring to a flowchart of a semiconductor device manufacturing or production method ST400 in a fully automatic line shown in FIG. 19.

The production method ST400 is different from the production method ST300 (see FIG. 7) in that steps ST403, ST404, and ST409 are used in place of the steps ST303, ST304, and ST309.

Specifically, in the step ST403, when the present process flag is “1”, as a result of flag judgment in the step ST302, the extraction means 220 refers to the process flow 261 and extracts all the processes of which flag is “1” from unexecuted processes (including the present process). At this stage, a processing object 290 is not yet treated.

In the step ST404, the adjustment means 230 fetches information related to the process loads of all the processes extracted in the step ST403 (the management means 240 may be used therefor), and assigns the processing object 290 to a process having a low process load (preferably, the lowest process load). At this time, the process of low process load may be selected with, for example, a method disclosed in Japanese Patent Unexamined Publication No. 3-290703.

In the step ST409, the processing object 290 is automatically transported by the interbay transportation system 315 etc.

In the fully automatic line, the equipments used in the steps ST305 and ST306 are controlled by the production management system 200 through the PCs.

The foregoing operation produces the same effect as in the first preferred embodiment. In particular, the process load reference in the operation of the second preferred embodiment enables to take proper handling to meet the situation, thereby further ensuring a reduction in production time. Therefore, proper handlings are possible in the absence of the above-mentioned authorized engineer because the execution order is automatically adjusted based on the judgment made by the adjustment means 230 in the step ST404.

Third Preferred Embodiment

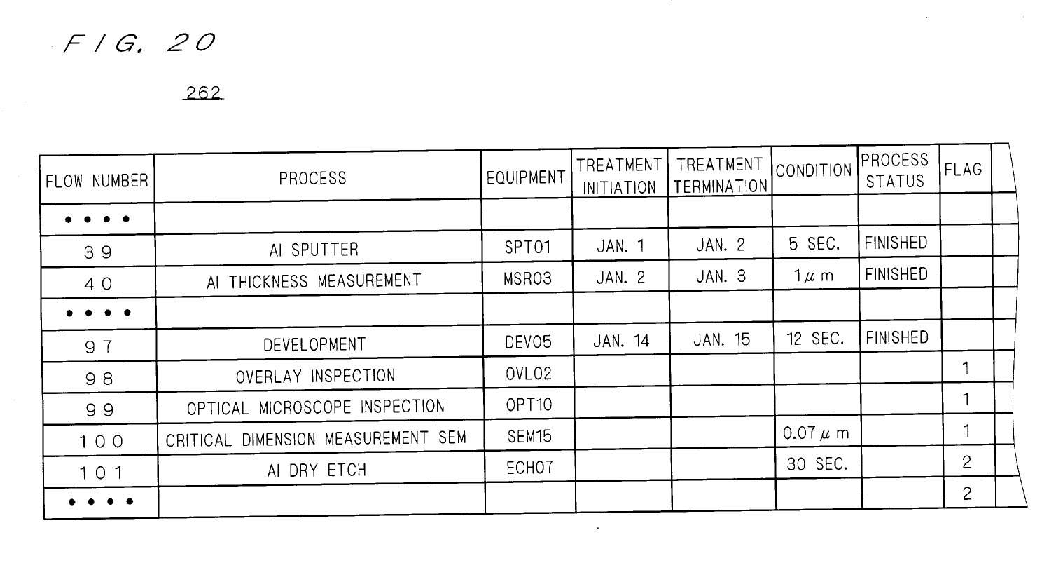

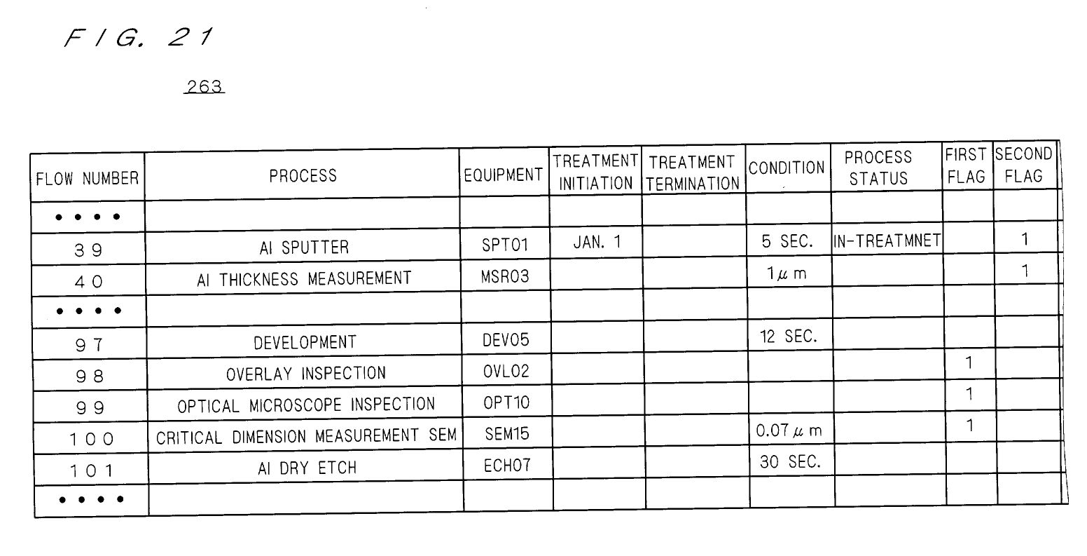

As a second specific example of the process flow 260, a process flow 262 according to a third preferred embodiment will be described by referring to FIG. 20. In the process flow 262, “1”, “2”, or blank is appended to each flag, as shown in FIG. 20. Other information (articles) of the process flow 262 are the same as in the above-mentioned process flow 261 in FIG. 6.

FIG. 20 shows the case that the flags of flow numbers 98 to 100 are set to “1” as in FIG. 6, and A1 dry etch process of process flow number 101 and the following processes are set to “2”.

Specifically, different types of identifiers such as the flag set to “1” and the flag set to “2” are used as the order adjustable information 270. This enables to define plural groups of order adjustable process and identify groups having adjacent flow numbers.

When the process flow 262 is applied to the operation of the first or second preferred embodiment, priority is established between the two different identifiers, flag of “1” and flag of “2”. For example, in the flag judgment step ST302, the processes of flag “2” are beyond the scope of flag judgment until all the processes having the flag “1” are executed.

By increasing the number of flag statuses, three or more types of identifiers can be used as the order adjustable information 270.

Fourth Preferred Embodiment

As a third specific example of the process flow 260, a process flow 263 according to a fourth preferred embodiment will be described by referring to FIG. 21. In the process flow 262 shown in FIG. 21, first and second flags are used instead of one type of flag in the process flow 261 of FIG. 6, and “1” is appended to each flag, as the order adjustable information 270. Other information (articles) of the process flow 263 are the same as in the process flow 261 of FIG. 6.

Specifically, FIG. 21 shows the case that the first flags of processes of flow numbers 98 to 100 are set to “1”, and the second flags of A1 sputter process of flow number 39 and A1 thickness measurement process of flow number 40 are set to “1”.

According to the process flow 263, the same effect as the process flow 262 in FIG. 20 is obtainable by using the first flag set to “1” and the second flag set to “1”, as different types of identifiers that indicate the order adjustable information 270.

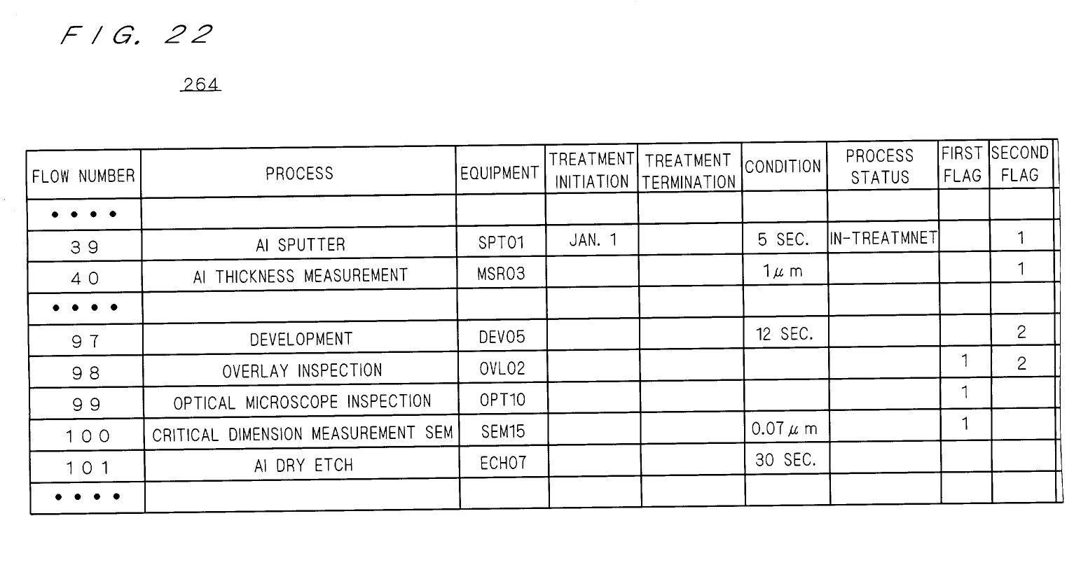

By increasing the number of flags, three or more types of identifiers can be used as the order adjustable information 270. In an alternative, three or more types of identifiers can be used by increasing the number of statuses per flag, as in the process flow 262 in FIG. 20. This alternative (a process flow 264) is shown in FIG. 22, as a fourth specific example of the process flow 260.

Fifth Preferred Embodiment

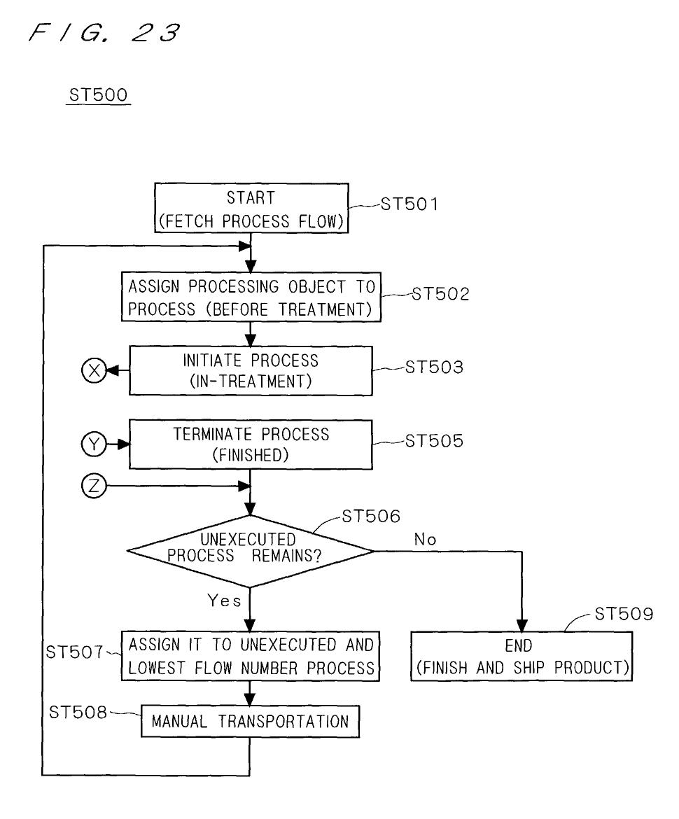

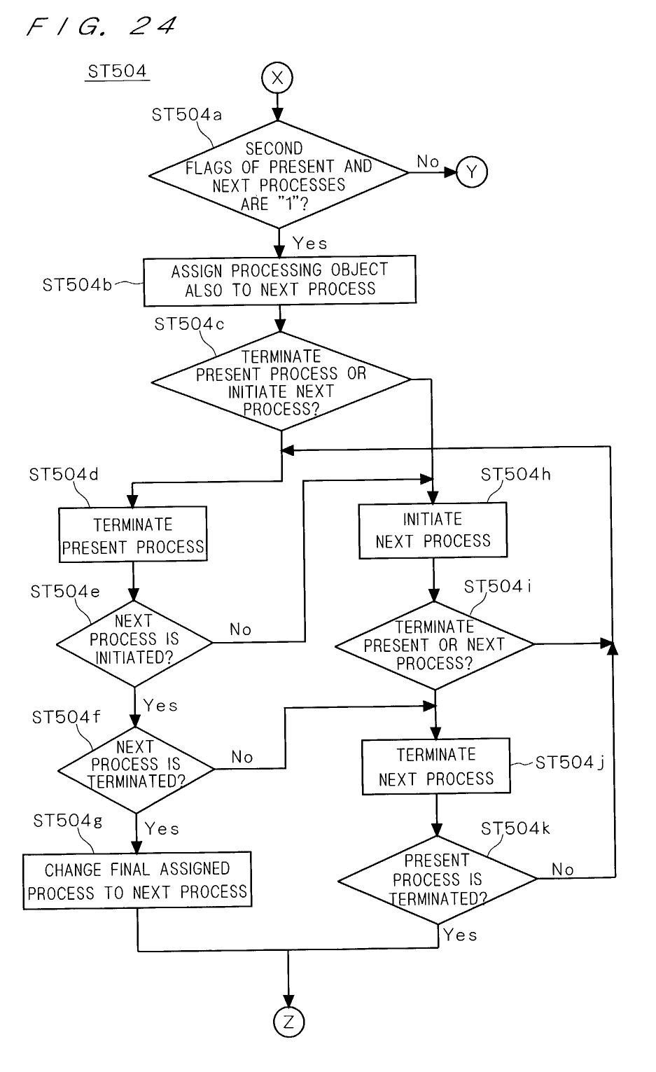

A fifth preferred embodiment is directed to the operation of a production management system 200 that is suitable for the case that the processing object 290 includes a product (or the second processing object) 291 but also a monitor product (or the first processing object) 292. The operation of the production management system 200 according to the fifth preferred embodiment will be described by referring to a flowchart of a semiconductor device manufacturing or production method ST500 in a manual line shown in FIGS. 23 and 24. The two figures are connected via connectors X, Y, and Z. Following is the instance that the production management system 200 uses the process flow 263 of FIG. 21 and refers to the illustrative information of the process flow 263 in FIG. 21.

In the production method ST500, as in the step ST301 of FIG. 7, the process flow fetch means 210 firstly fetches the process flow 263 (step ST501), and supplies materials to a production line.

Subsequently, the production management system 200 directs the management system 240 to assign a processing object 290 to the lowest flow number process among the unexecuted processes (step ST502). A line operator 317 operates to initiate the process (step ST503).

Thereafter, the operation of the production management system 200 goes to step ST504 shown in FIG. 24. The step ST504 includes steps ST504a to ST504k.

In the step ST504a, the extraction means 220 refers to the process flow 263, and judges whether the second flag of the present process (or the first process) to which the processing object 290 (production 291 and monitor product 292) is assigned and which is already initiated, and the second flag of the next process (or the second process) to which has a flow number next to that of the present process on the process flow, are both set to “1” (step ST504a). As a result of this flag judgment, the both second flags are “1”, the extraction means 220 assigns the processing object 290 not only to the present process but also the next process (step ST504b). On the other hand, when at least one of the second flags is not “1”, the operation goes to the step ST505 of FIG. 23, thereby to terminate the present process.

Then, under the production management system 200, the adjustment means 230 prompts the line operator 317 to select either the termination of the present process to both of the product 291 and monitor product 292, or the initiation of the next process to the monitor product 292 (step ST504c).

When the line operator 317 selects the termination of the present process, after the present process is terminated (step ST504d), the adjustment means 230 refers to the process flow 263 and investigates whether the next process is initiated (step ST504e).

When the next process is already initiated, the adjustment means 230 investigates whether the next process is terminated (step ST504f). When terminated, the finally assigned process of the processing object 290 is changed to this next process (i.e., assigned to the next process alone by canceling the assignment to the present process) (step ST504g), and the operation goes to step ST506 of FIG. 23.

On the other hand, when the next process initiation is selected in the step ST504c, and when the next process is not initiated as the investigation result in the step ST504e, the line operator 317 operates to initiate the next process (step ST504h). At this time, the adjustment means 230 prompts the line operator 317 to perform operation with a message display etc.

After the next process is initiated, the adjustment means 230 prompts the line operator 317 to select which of the present process and the next process should be first terminated (step ST504i). When the present process is selected, the operation goes to the step ST504d.

When the next process is selected in the step ST504i, and when the next process is not terminated as the investigation result in the step ST504f, the line operator 317 operates to terminate the next process (step ST504k). At this time, the adjustment means 230 prompts the line operator 317 to perform operation with a message display etc. Then, the adjustment means 230 investigates whether the present process is terminated (step ST504k). As the investigation result, when the present process is already terminated, the operation goes to step ST506 to be described later. When the present process is not yet terminated, the operation goes to the step ST504d.

The operation of the step ST504 in FIG. 24 is mainly executed by the adjustment means 230, and the management means 240 performs management of each process based on the result of adjustment made by the adjustment means 230, e.g., update of process status.

Returning to FIG. 23, after the steps ST504 and ST505 are terminated, there are executed steps ST506 to ST509 that are the same as the steps ST307 to ST310 in FIG. 7.

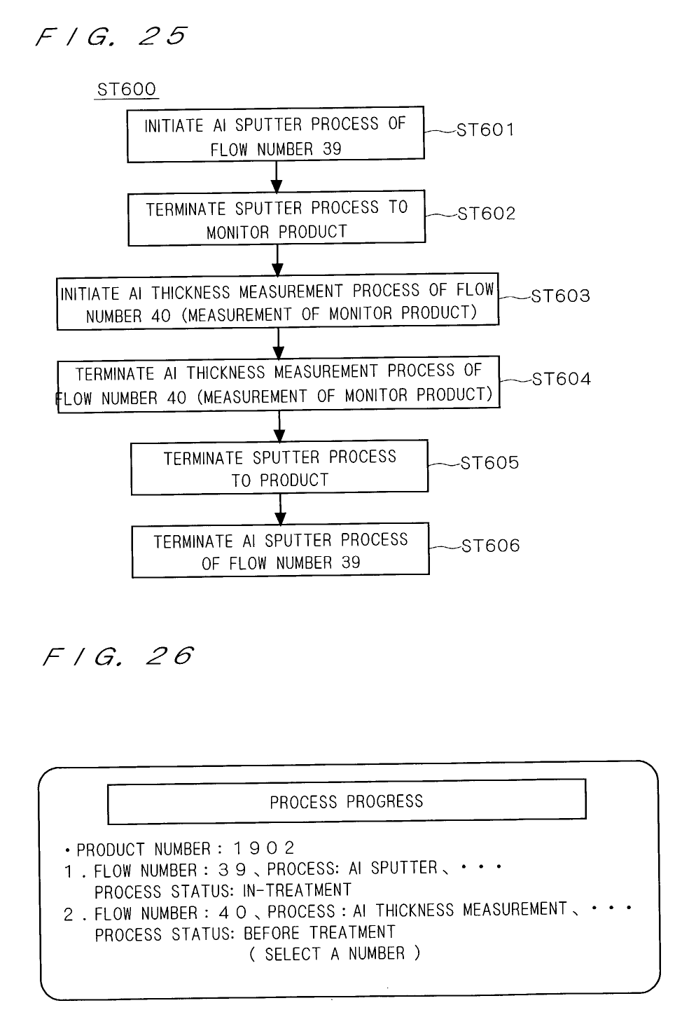

In order to make the step ST504 understandable, a description will be given of a semiconductor device manufacturing or production method ST600 shown in FIG. 25. In the production method ST600, A1 sputter process of flow number 39 is firstly initiated (step ST601). At this time, the A1 sputter process is first executed to a monitor product 292 and then to a product 291. After the sputter process to the monitor product 292 is terminated (step ST602), A1 thickness measurement process of flow number 40 to the monitor product 292 is initiated (step ST603) and then terminated (step ST604). Thereafter, sputter process to the product 291 is terminated (step ST605), thereby terminating the A1 sputter process of flow number 39 (step ST606).

With the production method ST600 in which before the present process of flow number 39, the next process of flow number 40 is terminated, in the step 504, the steps ST504a, ST504b, ST504c, ST504h, ST504i, ST504j, ST504k, ST504d, ST504e, ST504f, and ST504g are executed in this order named.

Consider now the instance that even if desired to firstly terminate the A1 thickness measurement process to the monitor product 292, the A1 sputter process to the product 291 must be firstly terminated due to the failure in A1 thickness measurement equipment MSR03. In this instance, in the step ST504, the steps ST504a, ST504b, ST504c, ST504h, ST504i, ST504d, ST504e, ST504f, ST504j, and ST504k are executed in this order named.

When desired to proceed with processes in the order of flow numbers as in the conventional case even if the second flag is “1” (including the instance of previously being informed of the failure in the equipment MSR03), in the step 504, the steps ST504a, ST504b, ST504c, ST504d, ST504e, ST504h, ST504i, ST504j, and ST504k are executed in this order named.

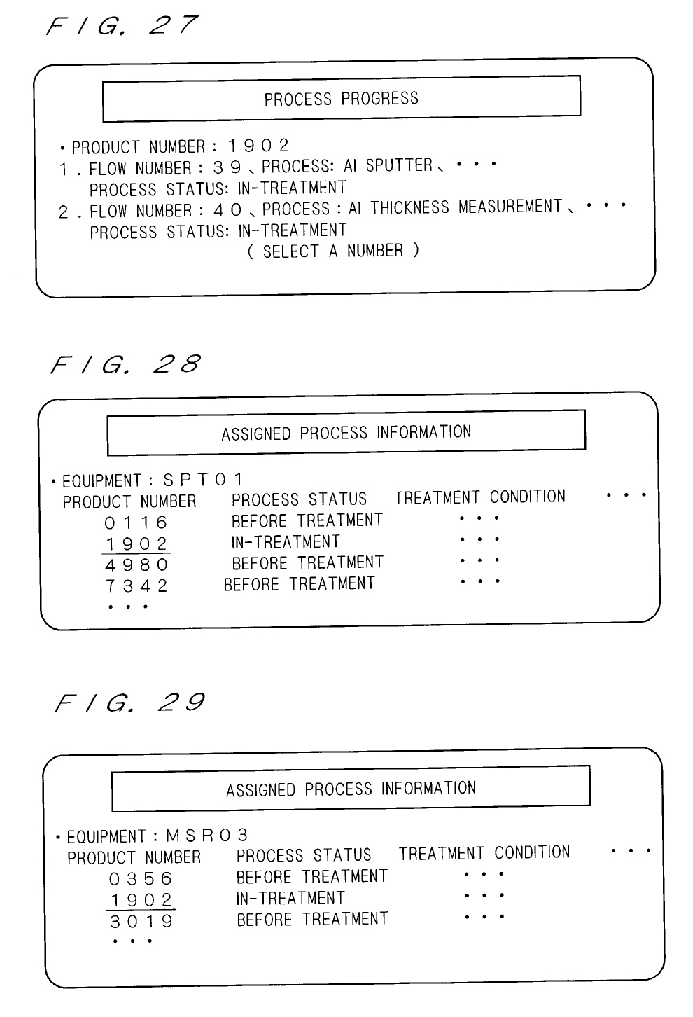

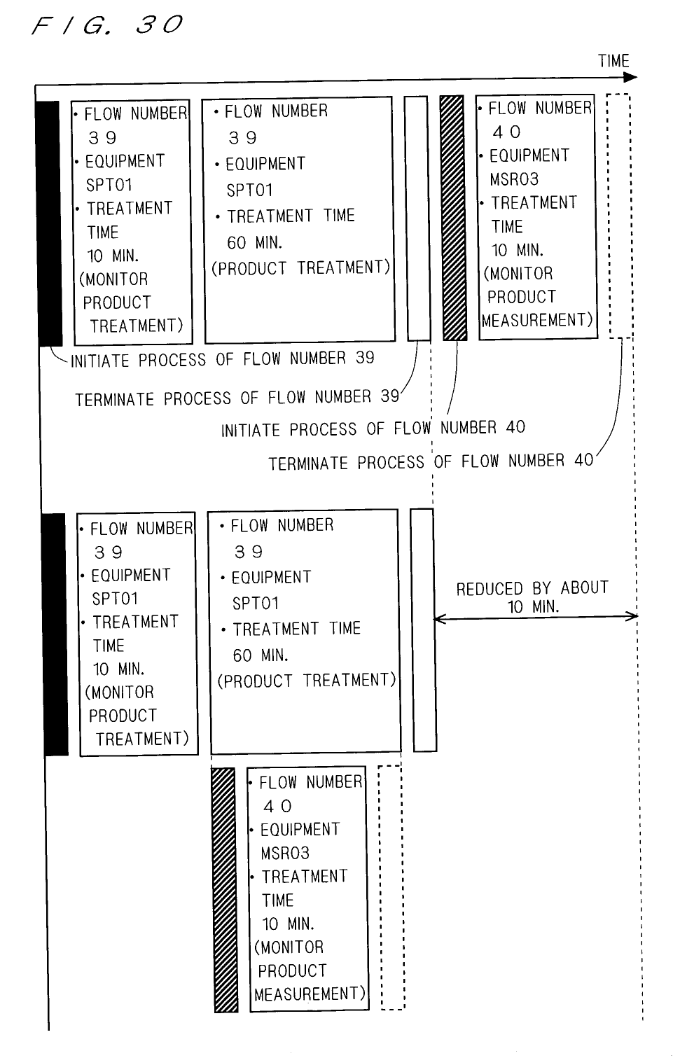

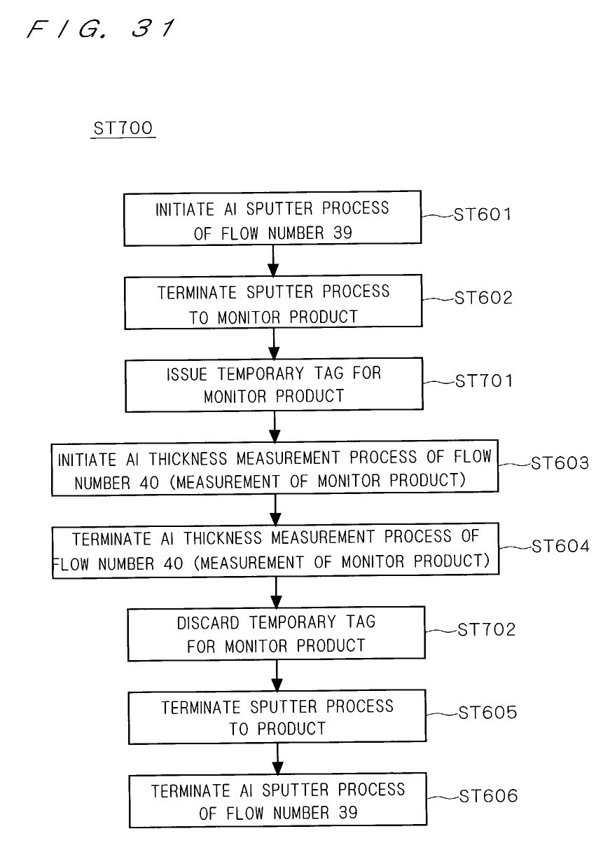

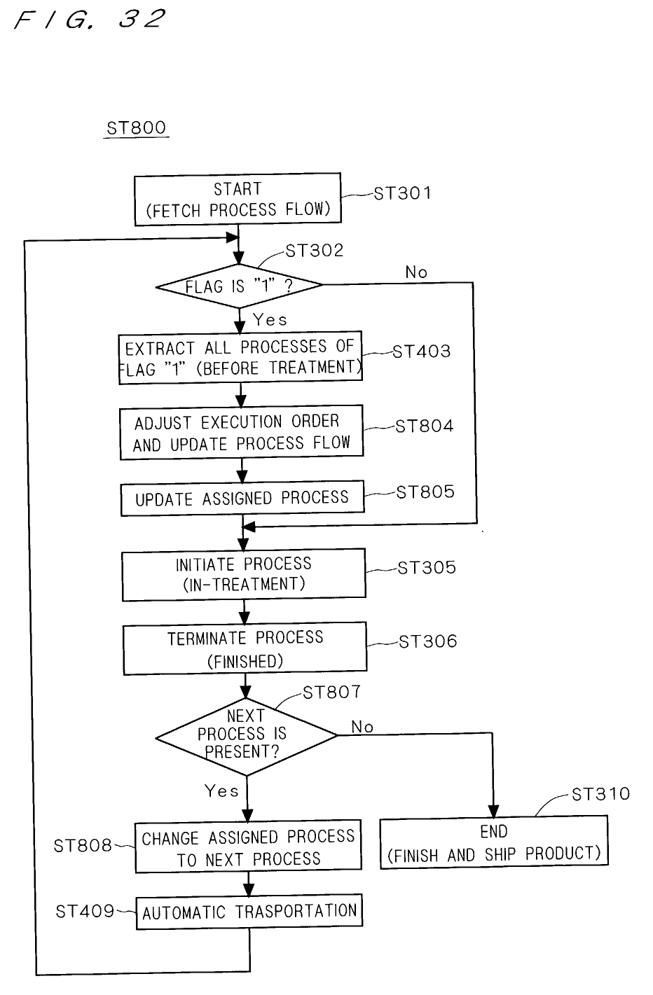

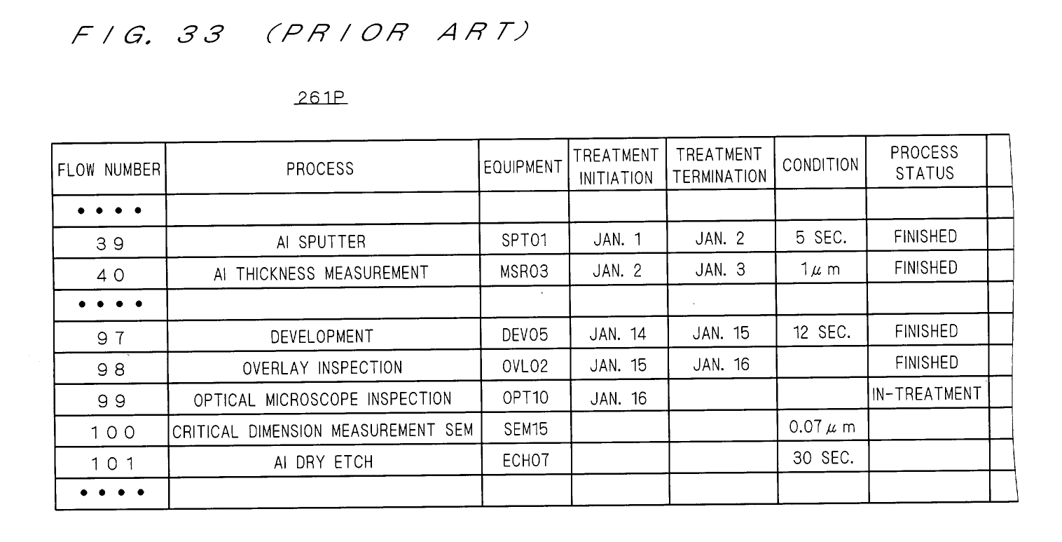

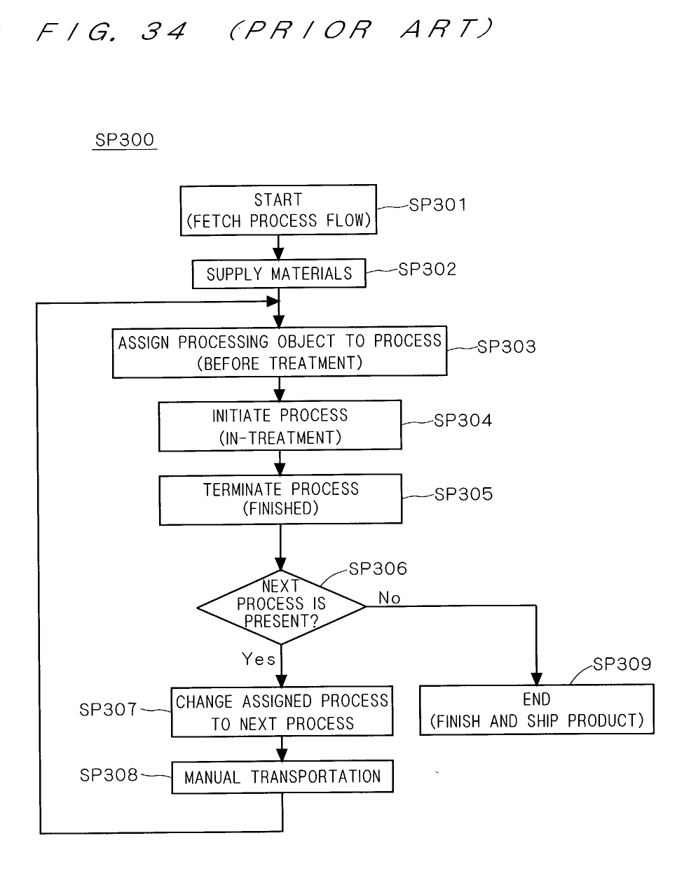

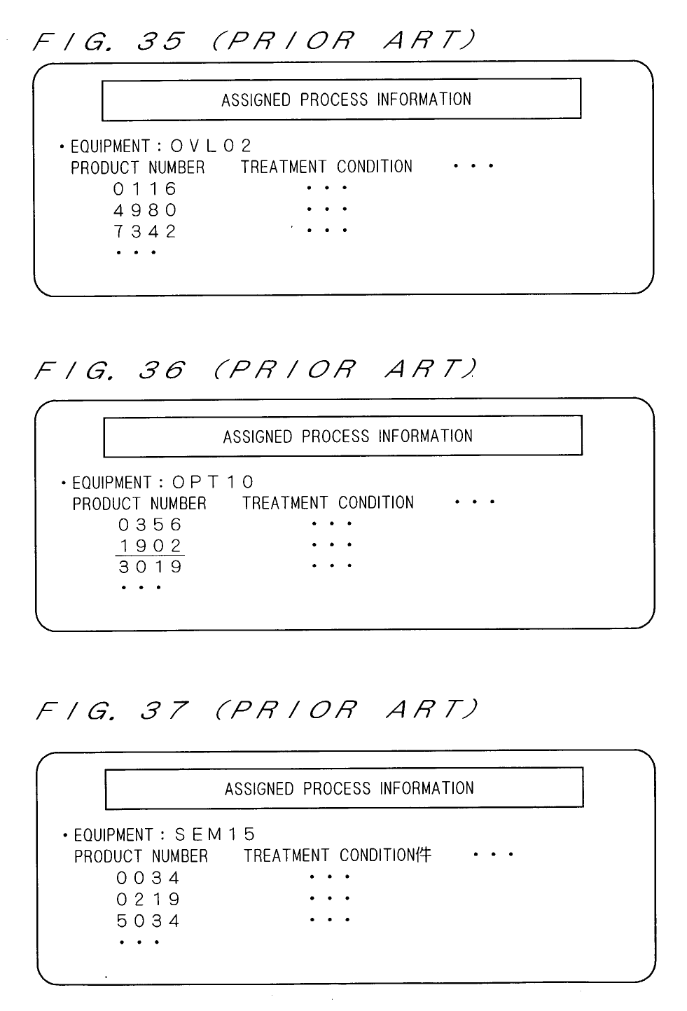

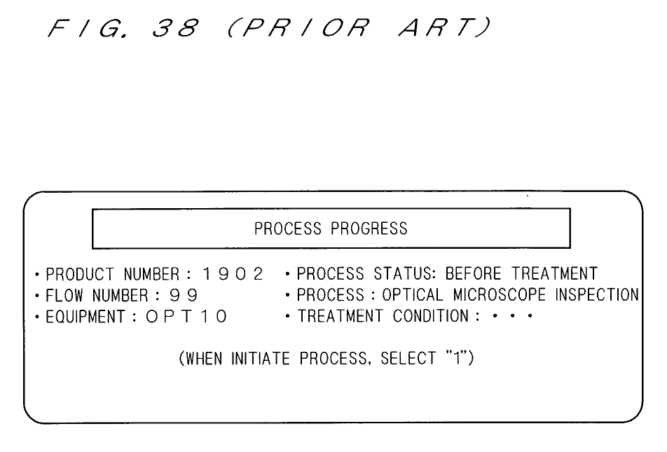

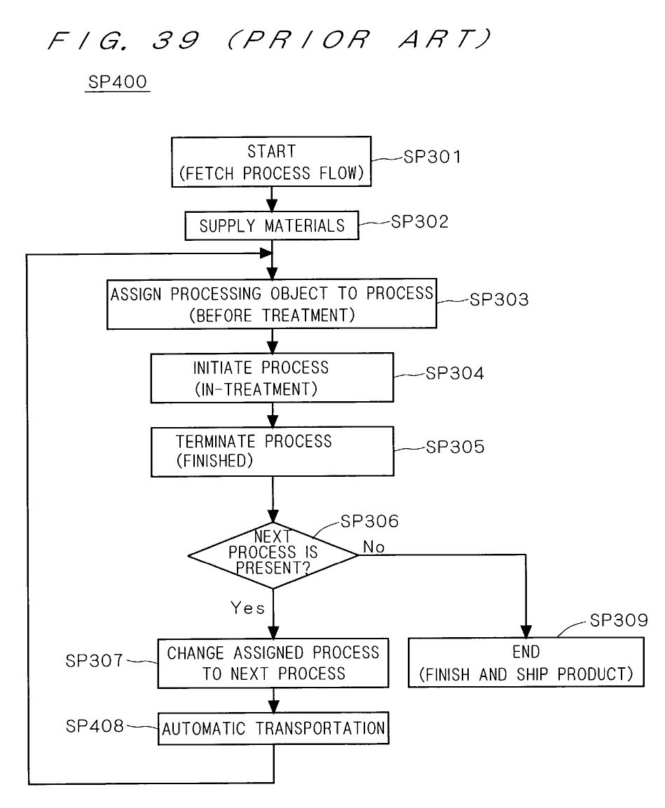

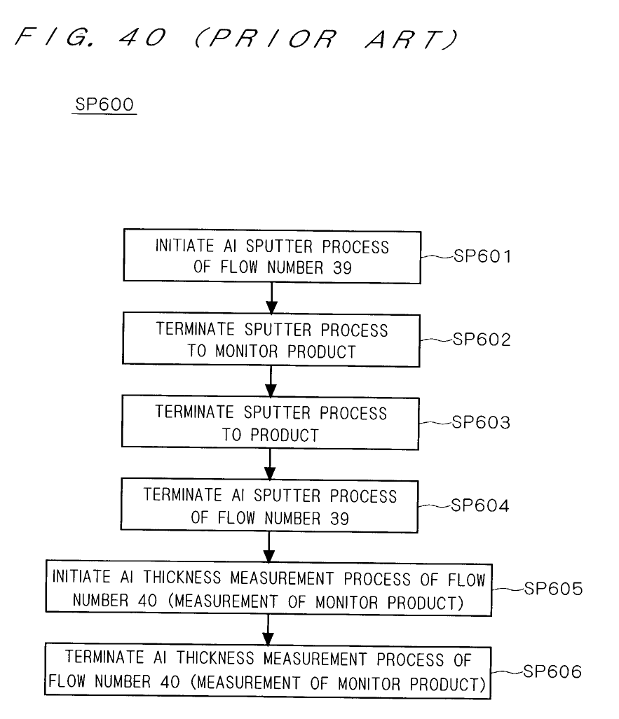

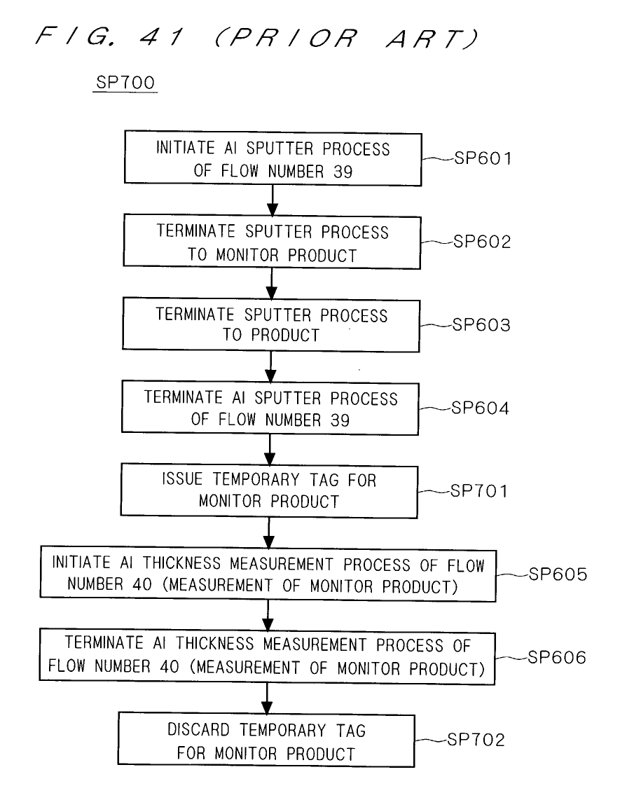

FIGS. 26 and 27 show examples of display screens to be displayed on the PCs in the steps ST504c and ST504i. As examples of display screens shown in FIGS. 28 and 29, the line operator 317 can see that the processing object 290 of production number “1902” is assigned to both of the A1 sputter process and A1 thickness measurement process, and treatments of both processes are being executed.

Thus, in the operation of the fifth preferred embodiment, the adjustment means 230 adjusts the execution order as follows: the monitor product (or the first processing object) 292 and product (or the second processing object) 291 are sequentially treated in this order in the A1 sputter process of flow number 39; after the A1 sputter process to the monitor product 292 is terminated, the A1 thickness measurement process of flow number 40 to the monitor product 292 is executed in parallel to the execution of A1 sputter process to the product 292. Referring to FIG. 30 that shows a comparison of time passage between the conventional production management system (the upper stage) and the production management system 200 (the middle and lower stages), the production time can be reduced by parallel treatment of the monitor product 292 and product 291 (about a 10-minute reduction is possible in the example of FIG. 30). This produces the same effect as in the first preferred embodiment.

Although in the production method ST500, the flag judgment (step ST504a) is executed after the present process is initiated (step ST503), it may be executed before the present process is initiated.

Although the foregoing description is directed to the instance of two processes, the operation of the fifth preferred embodiment is applicable to the instance of three or more processes, such a case that after a sputter process, there are plural measurement processes to a sputter film. Although in the foregoing description, the second flag set to “1” is used as an identifier, the above-mentioned other identifiers are also usable.

Sixth Preferred Embodiment

The above-mentioned production method ST500 is applicable to a fully automatic line. Specifically, the step ST508 is changed to an automatic transportation, and the production management system 200 controls through the PCs the corresponding equipments in the step ST503 etc. which require the operation of the line operator 317. In the step ST504c, for example, the termination of the present process or the initiation of the next process is selected by referring to the process loads as in the second preferred embodiment.

A sixth preferred embodiment is directed to a semiconductor device manufacturing or production method ST700 shown in FIG. 31. The production method ST700 is obtained by modifying the production method ST600 for manual line (see FIG. 25) so as to be used for fully automatic line. The production method ST700 is different from the production method ST600 of FIG. 25 in that step ST701 for issuing a temporary tag for monitor product is interposed between the steps ST602 and ST603, and that step ST702 for discarding the temporary tag for monitor product is interposed between the steps ST604 and ST605. The steps ST701 and ST702 are executed such that a monitor product 292 is automatically transported, by using the temporary tag, from the A1 sputter process to the A1 thickness measurement process. The temporary tag issue and discard may be performed by the adjustment means 230 or management means 240.

Also in this production method ST700, the production management system 200 operates like the above-mentioned production method ST600, and produces the above-mentioned effect.

Seventh Preferred Embodiment

The operation of production management system 200 according to a seventh preferred embodiment will be described by referring to a flowchart of a semiconductor device manufacturing or production method ST800 in a fully automatic line shown in FIG. 32.

The production method ST800 is different from the production method ST400 for fully automatic line (see FIG. 19) in that steps ST804 and ST805 are used in place of the step ST404.

Specifically, in the step ST804, the adjustment means 230 investigates the process loads of all the processes extracted in the step ST403 (i.e., fetches information related to the process loads), and adjusts the execution order of the extracted processes such that a lower load process has a lower flow number. Based on the adjustment result, the flow numbers are changed among the extracted processes, and the process flow 261 is updated. Thereafter, in the step ST805, the adjustment means 230 or management means 240 assigns a processing object 290 to the process of the lowest flow number (the lowest process load) among all the extracted processes, that is, updates the assigned process of the processing object 290.

The production method ST800 is different from the production method ST300 on a fully automatic line (see FIG. 19) in that steps ST807 and ST803 are used in place of the steps ST307 and ST308. Specifically, in the step ST807, the management means 240 refers to the process flow 261 and judges whether there is a process having a flow number next to that of the present process (i.e., the next process), as in the conventional step SP306 shown in FIG. 34. In the step ST808, the management means 240 changes the assigned process of the processing object 290 to the next process, as in the conventional step SP307 shown in FIG. 34.

At this time, according to the production method ST800, the production management system 200 changes the process flow 261 and, under the changed process flow 261, the system 200 proceeds with the processes in the order of ascending flow numbers, as in the conventional method. That is, the production management system 200 can be obtained easily by using the conventional production system that manages the processes in the order of flow numbers on the process flow 261.

It is noted that the steps ST307 and ST308 in the production method ST300 may be used as they are, without changing to the steps ST807 and ST808. In an alternative, the process flow 262, 263, and 264 may be used in the operation of the seventh preferred embodiment.

Modifications

It is of course possible to apply the production management system 200 to any production other than the semiconductor device production as described in the first to seventh preferred embodiments. It is apparent that the production management system 200 can concurrently (in parallel) manage plural processing objects 290.

While the invention has been shown and described in detail, the foregoing description is in all aspects illustrative and not restrictive. It is therefore understood that numerous modifications and variations can be devised without departing from the scope of the invention.

What is claimed is:

1. A production management system comprising:
a process flow fetch means for fetching a process flow having information about treatment of each process, a flow number of each said process, and information indicating whether an execution order of each said process is adjustable;
an extraction means that extracts, by referring to said process flow, plural unexecuted order adjustable processes each being unexecuted and having an order adjustable information indicating that its executing order is adjustable;
an adjustment means for adjusting an execution order of said plural unexecuted order adjustable processes; and
a management means for managing each said process based on a result of adjustment made by said adjustment means.

2. The production management system according to claim 1 wherein
said plural unexecuted order adjustable processes contain first and second processes, and
said adjustment means includes a first adjustment means for adjusting said execution order of said plural unexecuted order adjustable processes so that said first process is sequentially executed to first and second processing objects and said second process to said first processing object is executed concurrently with said first process to said second processing object.

3. The production management system according to claim 1 wherein
said adjustment means includes a second adjustment means that adjusts said executed order of said plural unexecuted order adjustable processes by referring to loads of said plural unexecuted order adjustable processes.

4. The production management system according to claim 1 wherein
said adjustment means includes a third adjustment means that adjusts said execution order of said plural unexecuted order adjustable processes, changes flow numbers among said plural unexecuted order adjustable processes based on an adjustment result, and updates said process flow.

5. The production management system according to claim 1 wherein
said order adjustable information is given by plural types of identifiers.
